(19) United States
(12) Patent Application Publication
(10) Pub. No.: US 2024/0327057 A1
(43) Pub. Date: Oct. 3, 2024

(54) PACKAGING ASSEMBLY AND OVEN COMPRISING SAME

(71) Applicant: SAMSUNG ELECTRONICS CO., LTD., Suwon-si Gyeonggi-do (KR)

(72) Inventors: Geunyong PARK, Suwon-si (KR); Keunseuk OH, Suwon-si (KR); Yuhwan JO, Suwon-si (KR)

(73) Assignee: SAMSUNG ELECTRONICS CO., LTD., Suwon-si Gyeonggi-do (KR)

(21) Appl. No.: 18/739,644

(22) Filed: Jun. 11, 2024

Related U.S. Application Data
(63) Continuation of application No. PCT/KR2022/015516, filed on Oct. 13, 2022.

(30) Foreign Application Priority Data
Dec. 17, 2021 (KR) 10-2021-0181874

(51) Int. Cl. B65D 5/44

(52) U.S. Cl. CPC B65D 5/44

(57) ABSTRACT

A packaging assembly for packaging cookware for an oven having a cooking chamber. The packaging assembly comprises a first packaging material and a second packaging material in contact with the first packaging material where the first packaging material (comprises a first accommodation space which is open toward the second packaging material, and the second packaging material comprises a second accommodation space which is open toward the first packaging material The packaging assembly has an external shape corresponding to the cooking chamber and can be accommodated in the cooking chamber, and the length of the first packaging material along a direction from the surface of the first packaging material where the first packaging material and the second packaging material come into contact with each other is longer than the length of the second packaging material along the direction.

### CROSS-REFERENCE TO RELATED APPLICATIONS

This application is a continuation of International Application PCT/KR2022/015516, filed Oct. 13, 2022, and claims foreign priority to Korean Application 10-2021-0181874, filed Dec. 17, 2021, the disclosures of which are incorporated herein by reference in their entireties.

### TECHNICAL FIELD

The following embodiment relates to an oven including a packaging assembly.

### BACKGROUND ART

An oven may typically include a cooking chamber, a heater providing heat to the cooking chamber, and a fan generating a flow for circulating heat generated by the heater in the cooking chamber. The oven may cook food in the cooking chamber by heat circulating in the cooking chamber.

The oven may be classified as an electronic oven, a gas oven, or an electric oven depending on the heat source used by a heater.

The electronic oven, in other words, a microwave oven, may generate heat by causing friction between water molecules using microwaves. The gas oven may generate heat using gas. The electric oven may generate heat using an electric heater, such as a heating wire.

More specifically, the oven may include a cooking chamber, which is formed inside a main body and into which food to be cooked is inserted, and a door that is disposed on a front surface of the main body and opens or closes the cooking chamber.

The above description is information the inventor(s) acquired during the course of conceiving the present disclosure, or already possessed at the time and is not necessarily art publicly known before the present application was filed.

### SUMMARY

According to various embodiments, a packaging assembly for easily packaging a packaged accessory or cookware therein may be provided.

According to various embodiments, a packaging assembly for completing packaging by easily combining packaging materials may be provided.

According to various embodiments, a packaging assembly for accommodating various accessories or cookware in a limited space without damage may be provided.

According to various embodiments, an oven for reducing a customer delivery cost by accommodating a packaging assembly in an inner space of the oven may be provided.

According to various embodiments, a packaging assembly for packaging cookware for an oven including a cooking chamber therein may include a first packaging material and a second packaging material in contact with the first packaging material, wherein the first packaging material may include a first accommodation space that is open toward the second packaging material, the second packaging material may include a second accommodation space that is open toward the first packaging material, the packaging assembly may include an external figure corresponding to the cooking chamber to be accommodated in the cooking chamber, and a length of the first packaging material along a direction of the first packaging material from a surface of the first packaging material that contacts the second packaging material may be greater than a length of the second packaging material in the direction.

According to various embodiments, a packaging assembly for packaging an accessory of a home appliance product including a cavity therein may include a first packaging material and a second packaging material in contact with the first packaging material, wherein the first packaging material may include a first accommodation space that is open toward the second packaging material, the second packaging material may include a second accommodation space that is open toward the first packaging material, when the first packaging material is in contact with the second packaging material, the first accommodation space may be connected to the second accommodation space, the packaging assembly may include an external figure corresponding to the cavity to be accommodated in the cavity, and a length of the first packaging material in a first direction toward the first packaging material from a surface in which the first packaging material and the second packaging material are in contact with each other may be greater than a length of the second packaging material in the first direction.

According to various embodiments, an oven may include a main body, a cooking chamber, which is provided in the main body, is open toward one side of the main body, and has a hexahedral shape, a door that opens and closes the cooking chamber in the one side of the main body, a control panel installed in the main body at an upper portion of the one side of the main body, and a packaging assembly accommodated in the cooking chamber, wherein the packaging assembly may include a first packaging material and a second packaging material in contact with the first packaging material, the first packaging material may include a first accommodation space that is open toward the second packaging material, the second packaging material may include a second accommodation space that is open toward the first packaging material, the packaging assembly may include an external figure corresponding to the cooking chamber to be accommodated in the cooking chamber, a length of the first packaging material in a first direction toward the first packaging material from a surface in which the first packaging material and the second packaging material are in contact with each other may be greater than a length of the second packaging material in the first direction, the first packaging material may include at least one first separation rib, at least a portion of the first separation rib may continuously protrude toward a center of the first accommodation space from an inner surface of the first packaging material, the second packaging material may include at least one second separation rib, and at least a portion of the second separation rib may continuously protrude toward a center of the second accommodation space from an inner surface of the second packaging material, and a protruding length of a protruding portion in the first direction of the at least one of the second separation ribs may be less than or equal to a protruding length of a protruding portion in a direction that is opposite to the first direction of the at least one of the first separation ribs.

### BRIEF DESCRIPTION OF DRAWINGS

FIG. 1 is a perspective view of an oven according to one embodiment.

FIG. 2 illustrates a state in which a door of an oven is open according to one embodiment.

FIG. 3 is a cross-sectional side view of an oven according to one embodiment.

FIG. 4 illustrates a state in which a door is open while tray-type cookware is disposed in an oven according to one embodiment.

FIG. 5 is a perspective view of a multipurpose tray disposed in an oven according to one embodiment.

FIG. 6 is a perspective view of a tray for air frying disposed in an oven according to one embodiment.

FIG. 7 is a perspective view of a tray for steaming disposed in an oven according to one embodiment.

FIG. 8 is a perspective view of a glass for steaming disposed in an oven according to one embodiment.

FIG. 9 is a perspective view of a sub-tray for steaming disposed on a tray for steaming disposed in an oven according to one embodiment.

FIG. 10 is a perspective view of wire-type cookware disposed in an oven according to one embodiment.

FIG. 11 is a perspective view of a steam pipe disposed in an oven according to one embodiment.

FIG. 12 is a perspective view of a packaging assembly according to one embodiment.

FIG. 13 is a perspective view of a first packaging material of a packaging assembly according to one embodiment.

FIG. 14 is a perspective view of a second packaging material of a packaging assembly according to one embodiment.

FIG. 15 illustrates an accommodation relationship and a combination relationship between a packaging assembly and cookware that may be accommodated in the packaging assembly according to one embodiment.

FIG. 16 illustrates a state in which a door of an oven including a packaging assembly is open according to one embodiment.

FIG. 17 is a side view of a packaging assembly according to one embodiment.

FIG. 18 is a plan view of a packaging assembly according to one embodiment.

FIG. 19 is a cross-sectional view of a first packaging material of a packaging assembly taken along line B-B according to one embodiment.

FIG. 20 is a cross-sectional view of a second packaging material of a packaging assembly taken along line A-A according to one embodiment.

FIG. 21 is a cross-sectional view of a packaging assembly taken along line D-D according to one embodiment.

FIG. 22 is a cross-sectional view of a packaging assembly taken along line C-C according to one embodiment.

### DETAILED DESCRIPTION

Hereinafter, embodiments will be described in detail with reference to the accompanying drawings. However, various alterations and modifications may be made to the embodiments. Here, the embodiments are not construed as limited to the disclosure. The embodiments should be understood to include all changes, equivalents, and replacements within the idea and the technical scope of the disclosure.

The terminology used herein is for the purpose of describing particular example embodiments only and is not to be limiting of the example embodiments. As used herein, the singular forms “a”, “an”, and “the” include the plural forms as well, unless the context clearly indicates otherwise. It will be further understood that the terms “comprises/comprising” and/or “includes/including” when used herein, specify the presence of stated features, integers, steps, operations, elements, and/or accessories, but do not preclude the presence or addition of one or more other features, integers, steps, operations, elements, accessories and/or groups thereof.

Unless otherwise defined, all terms including technical and scientific terms used herein have the same meaning as commonly understood by one of ordinary skill in the art to which the embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

When describing the embodiments with reference to the accompanying drawings, like reference numerals refer to like constituent elements and a repeated description related thereto will be omitted. In the description of example embodiments, detailed description of well-known related structures or functions will be omitted when it is deemed that such description will cause ambiguous interpretation of the present disclosure.

Also, in the description of the components, terms such as first, second, A, B, (a), (b) or the like may be used herein when describing components of the present disclosure. These terms are used only for the purpose of discriminating one constituent element from another constituent element, and the nature, the sequences, or the orders of the constituent elements are not limited by the terms. When one constituent element is described as being “connected”, “coupled”, or “attached” to another constituent element, it should be understood that one constituent element can be connected or attached directly to another constituent element, and an intervening constituent element can also be “connected”, “coupled”, or “attached” to the constituent elements.

The constituent element, which has the same common function as the constituent element included in any one embodiment, will be described by using the same name in other embodiments. Unless disclosed to the contrary, the configuration disclosed in any one embodiment may be applied to other embodiments, and the specific description of the repeated configuration will be omitted.

According to various embodiments, an accessory packaged inside or cookware may be easily packaged.

According to various embodiments, packaging may be completed by easily combining packaging materials.

According to various embodiments, various accessories or cookware may be accommodated in a limited space without damage.

According to various embodiments, a customer delivery cost may be reduced by accommodating a packaging assembly in an inner space of the package assembly.

The effects of a packaging assembly and an oven including the same according to various embodiments may not be limited to the above-mentioned effects, and other unmentioned effects may be clearly understood from the following description by one of ordinary skill in the art.

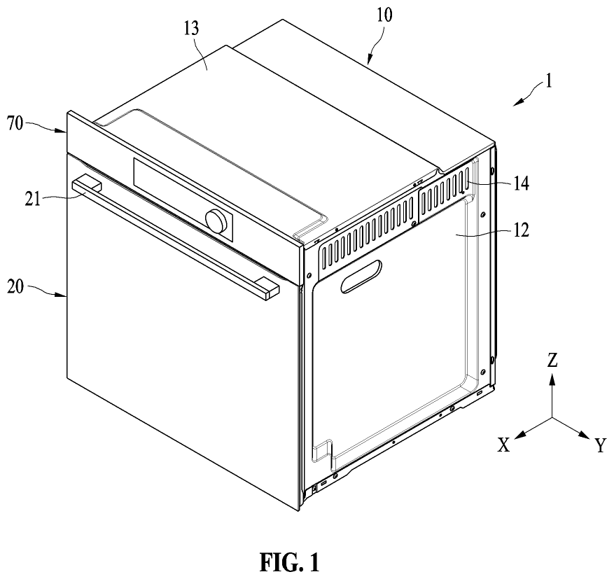

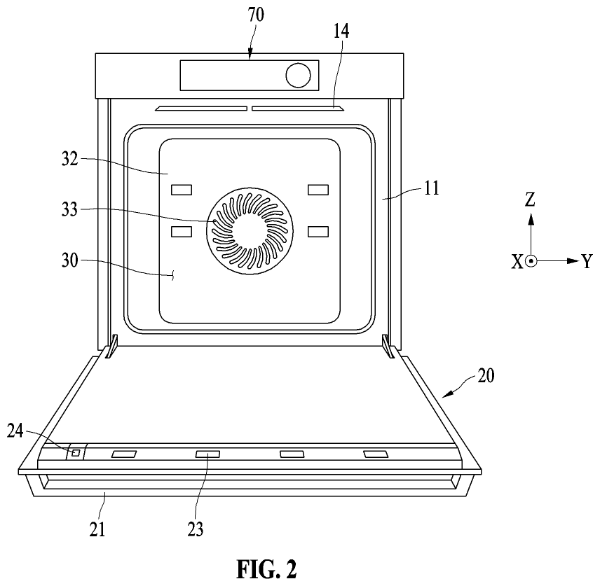

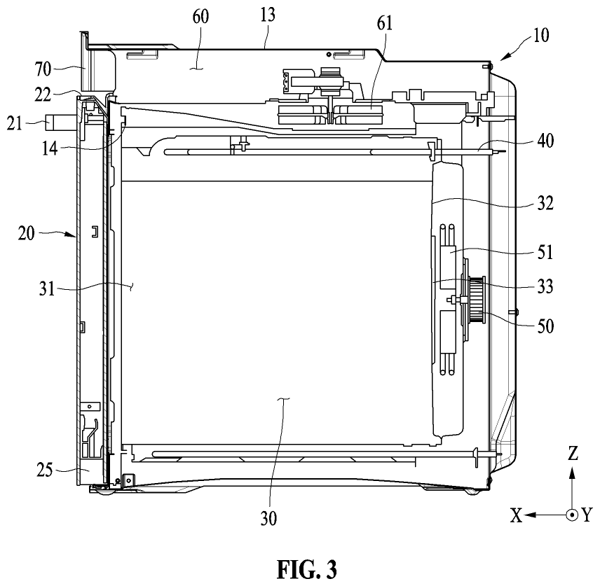

FIG. 1 is a perspective view of an oven 1 according to one embodiment, FIG. 2 illustrates a state in which a door 20 of the oven 1 is open according to one embodiment, and FIG. 3 is a cross-sectional side view of the oven 1 according to one embodiment.

Referring to FIGS. 1 to 3, the oven 1 may include a main body 10 forming an overall external figure of the oven 1, a cooking chamber 30 that is provided inside the main body 10 and is open toward one side of the main body 10, and a door 20 that forms the overall external figure of the oven 1 with the main body 10 and opens and closes the cooking chamber 30 from one side of the main body 10.

The main body 10 may have a hexahedral shape. The main body 10 may include a front panel 11 disposed toward a first direction (e.g., the +x direction of FIGS. 1 to 3) of the main body 10, an upper panel 13 disposed toward a second direction (e.g., the +z direction of FIGS. 1 to 3) of the main body 10, a side panel 12 disposed toward a third direction (e.g., the +y direction of FIGS. 1 to 3) of the main body 10, and a rear panel disposed on an opposite side to the front panel 11.

For example, since the oven 1 may be built-in or installed as a fixture, the side panel 12 and the rear panel may not be exposed to a user in a normal use environment. In this case, the side panel 12 and the rear panel may be designed from a thermal efficiency perspective and an exterior accessory (not shown) or garnish (not shown) for preventing exposure of the side panel 12 and the rear panel to the user may not be disposed.

An intake hole 14 through which air may pass may be formed in the front panel 11 and the side panel 12. This may allow air communication of an electronic component chamber 60 disposed between the cooking chamber 30 and the upper panel 13 with the outside. This may be for cooling electronic components disposed in the electronic component chamber 60. The electronic component chamber 60 will be described later.

The cooking chamber 30 may be provided inside the main body 10 and may have a hexahedral shape of which a front surface in the first direction (e.g., the +x direction of FIGS. 1 to 3) is open toward an opening 31. Through the opening 31 of the cooking chamber 30, a user may place food in the cooking chamber 30 and may take the food from the cooking chamber 30 during or after cooking.

A heater 40 for supplying heat to food may be disposed in the second direction (e.g., the +z direction of FIGS. 1 to 3) of the cooking chamber 30. As described above, the heater 40 may be an electric heater using heat generated when a current flows through an object having resistance or may be a gas heater for supplying heat to food by combusting gas. The heater 40 of the oven 1 is not limited to the electric heater or gas heater described above and may be various heaters.

For example, when the heater 40 is an electric heater, a plurality of heating wires included in the heater 40 on the top surface of the cooking chamber 30 in which the heater 40 is disposed may be arranged at intervals in the first direction or the third direction. In addition, the heating wire included in the heater 40 may be disposed on the top surface of the cooking chamber 30 in a concentric circle shape or may be disposed on the top surface of the cooking chamber 30 in a rectangular shape.

Furthermore, a position of the heater 40 may be placed in a location other than the second direction (e.g., the +z direction of FIGS. 1 to 3) of the cooking chamber 30 depending on the design reason. For example, the heater 40 may be disposed on an inner side surface in the third direction (e.g., the +y direction of FIGS. 1 to 3) of the cooking chamber 30 and/or an inner side surface in the opposite direction thereto.

Furthermore, the heater 40 may include a plurality of sub-heaters (not shown). For example, one of the sub-heaters (not shown) may be disposed on a side facing the third direction on a surface facing the second direction of the cooking chamber 30 and the other sub-heater may be disposed on the opposite side to the third direction. In this case, each sub-heater (not shown) may be individually controlled and may individually generate heat.

A circulation fan 51 for forcibly flowing heat supplied to the cooking chamber 30 and a circulation motor 50 for operating the circulation fan 51 may be disposed in an opposite direction (e.g., the −x direction of FIGS. 1 to 3) to the first direction (e.g., the +x direction of FIGS. 1 to 3) of the cooking chamber 30.

For example, when the circulation fan 51 is not operated, in the case of food inside the cooking chamber 30, a portion of the food close to the heater 40 (e.g., a portion of the food facing the second direction when the heater 40 is disposed on a surface in the second direction in the cooking chamber 30) may be intensively heated, but when a circulation apparatus including the circulation fan 51 and the circulation motor 50 is operated, an entirety of the food may be heated by forcibly flowing the heat inside the cooking chamber 30 by the circulation apparatus including the circulation fan 51 and the circulation motor 50.

A fan cover 32 for dividing a space where food is disposed and a space where the circulation fan 51 is disposed in the cooking chamber 30 may be disposed on the first direction (e.g., the +x direction of FIGS. 1 to 3) side of the circulation fan 51. The fan cover 32 may prevent the food from directly being in contact with the circulation fan 51 and/or the circulation motor 50.

For example, the circulation fan 51 and/or the circulation motor 50 may include an electrical accessory, such as wiring for receiving power, and when the electrical accessory is exposed to moisture of food, the circulation fan 51 and/or the circulation motor 50 may break down due to a short circuit, and thereby, the fan cover 32 may be disposed to prevent an inflow of moisture and the like.

In addition, for example, when food is in contact with a rotating blade of the circulation fan 51, the food may be crushed due to a rotational force of the blade and the inside of the cooking chamber 30 may be contaminated. Therefore, the fan cover 32 may be disposed for the management and cleanliness of the oven 1.

A through hole 33 may be formed in the fan cover 32 such that air impelled by the circulation fan 51 may enter the cooking chamber 30. The through hole 33 may include, for example, a plurality of holes and each of the holes may be a curved slit.

A slider dividing upper and lower spaces of the cooking chamber 30 may be inserted into the cooking chamber 30 to use a space of the cooking chamber more efficiently 30. A structure (e.g., a slit or a groove) into which the slider is inserted may be formed on the third direction (e.g., the +y direction of FIGS. 1 to 3) of the cooking chamber 30 and a side wall that is opposite to the third direction side. A plurality of sliders may be provided. Accordingly, the cooking chamber 30 may be divided into two or more spaces. The slider may be formed of a thermal insulating material and may vary temperatures between the divided cooking chambers 30. A through hole or a through part may be formed in the slider for fluid communication between spaces divided by the slider. For example, the length of the slider in the first direction may be shorter than the length of an inner space of the cooking chamber 30 in the first direction and in this case, when the slider is completely inserted into the inside of the cooking chamber 30, an open space for divided spaces to fluidly communicate with each other may be formed.

Furthermore, other than the slider described above, a divider for dividing the space of the cooking chamber 30 into left and right sides may be disposed in the cooking chamber 30. For example, the spaces divided into left and right sides by the divider may be individually heated by the plurality of sub-heaters (not shown) described above.

The door 20 may be hinge-coupled to a lower part of the main body 10 and may rotate relative to the main body 10. The opening 31 of the cooking chamber 30 may be opened or closed by the door 20 by the rotation around a hinge axis. A door handle 21 formed in a direction away from the cooking chamber 30 may be disposed on an end in the second direction (e.g., the +z direction of FIGS. 1 to 3) side of the door 20. The door handle 21 may be elongated in a direction toward the third direction (e.g., the +y direction of FIGS. 1 to 3) and the user may open or close the door 20 by gripping a gripping portion, which has a prismatic or cylindrical shape, of the door handle 21.

Furthermore, the door 20 may be hinge-coupled to an end in the third direction (e.g., the +y direction of FIGS. 1 to 3) side or an end on the opposite side of the opening 31 of the cooking chamber 30. In this case, the door 20 may be open or closed by rotating relative to the main body 10 around the z-axis.

A door duct 22 may be provided at an upper part of the door 20 and the door duct 22 may include a discharge hole 23 that discharges high-temperature air in the door 20 to the outside of the door 20.

An air inlet 25 that inhales external air to the inside the door 20 may be provided at a lower part of the door 20.

In addition, the door 20 may include a transparent member (e.g., plastic, tempered glass, etc.) (not shown) and a support frame (not shown) for supporting the transparent member. For example, the door 20 may include a support frame in which a through part is formed in the center of the surface and tempered glass attached to the support frame and the user may visually observe a cooking state of food inside the cooking chamber 30 through the transparent tempered glass and the through part of the support frame. In addition, for example, the door 20 may be designed without including a transparent member for observing the inside to reduce emission of heat from the cooking chamber 30 to the outside. In this case, the oven 1 may display a cooking state of food in the cooking chamber 30 on a display to the user and may include an observation means (e.g., a camera) in the cooking chamber to collect information for displaying.

As described above, the electronic component chamber 60 may be disposed between the cooking chamber 30 and the upper panel 13. The electronic component chamber 60 may accommodate electronic components for controlling various part units provided in the oven. For example, the electronic components may include a printed circuit board (PCB), a microprocessor, and the like.

Since the electronic components disposed in the electronic component chamber 60 may be sensitive to a temperature change, it may be preferable to not heat the electronic component chamber 60 unlike the cooking chamber 30. For example, the temperature of the cooking chamber 30 of the oven may rise to 150 to 450 degrees Celsius and because of a temperature difference between the cooking chamber 30, which is hot, and the electronic component chamber 60, which is not directly heated, heat transfer may occur. For this, a thermal insulating means to reduce heat transferred from the heater 40 and/or a cooling means to cool an electronic component may be provided in the oven 1.

For example, an insulator (not shown) for preventing heat generated by the heater 40 may be provided between the electronic component chamber 60 and the cooking chamber 30. Furthermore, the insulator (not shown) may entirely cover the outside of the cooking chamber 30 to prevent heat supplied to the cooking chamber 30 from being transferred to the outside of the cooking chamber 30.

In addition, for example, a cooling fan 61 may be provided in the electronic component chamber 60 as a cooling means. As the cooling fan 61 rotates, air in the electronic component chamber 60 may circulate and thereby electronic components may be cooled. In this case, as described above, air may be inhaled through the intake hole 14 formed in the side panel 12 and the inhaled air may cool the electronic component with a flow generated by the rotation of the cooling fan 61.

A control panel 70 may be disposed in the first direction (e.g., the +x direction of FIGS. 1 to 3) side of the electronic component chamber 60 or the second direction (e.g., the +z direction of FIGS. 1 to 3) side of the door 20.

For example, a display module, which is configured to display operation information of the oven 1 and to which an operation command is input as an interaction of a user through a touch screen, may be provided in the control panel 70. For example, the display module may display a power state of the oven, an open or closed state of the door 20, an operation state of the heater 40, the circulation fan 51 and/or the cooling fan 61, a temperature of the cooking chamber 30, and/or a temperature of each section of the cooking chamber 30 and the user may input an operation command related to a target temperature in the cooking chamber 30, a heating time, and the like, through the display module.

In one embodiment, a manipulation part that is provided separately from the touch screen may be disposed in one side of the display module. For example, the manipulation part may be formed in various known types in the art, such as a rotatable dial knob, a click switch, or a slider.

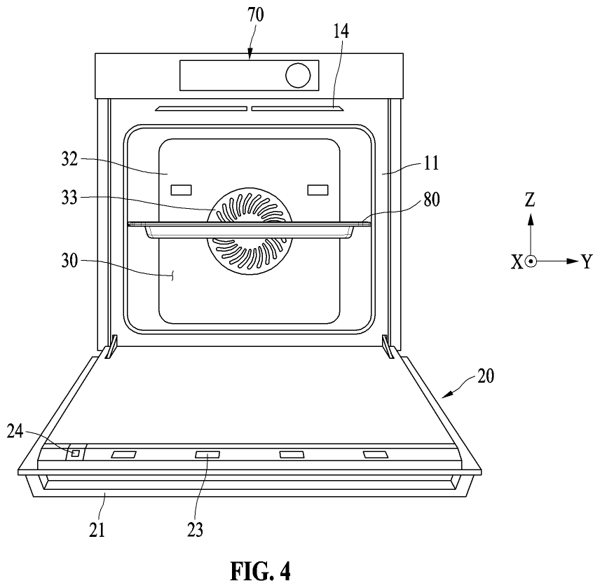

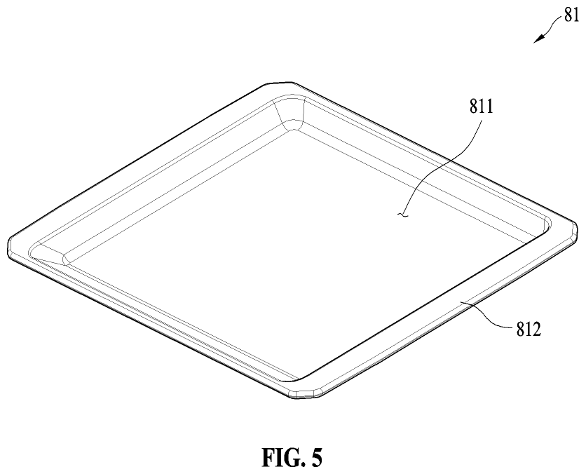

FIG. 4 illustrates a state in which the door 20 is open while tray-type cookware 80 (e.g., a multipurpose tray 81 of FIG. 5) is disposed in an oven according to one embodiment.

The user may cook food by placing food on a bottom surface of the cooking chamber 30 of the oven and operating the oven, but the user may use the cookware 80 for accommodating food to easily clean the cooking chamber 30 by preventing the food from being in direct contact with the cooking chamber 30, or to place the food, which is a cooking target, closer to, for example, the heater disposed on the upper part of the cooking chamber 30, or to evenly cook the food including the bottom surface thereof by the heat transferred from the heated bottom surface of the cooking chamber 30 by spacing the food apart from the bottom surface of the cooking chamber 30.

For example, tray-type cookware (e.g., the multipurpose tray 81 of FIG. 5) that may contain food to prevent moisture or oil from the food from leaking into the cooking chamber may be used. The tray-type cookware (e.g., the multipurpose tray 81 of FIG. 5) may be, for example, disposed on the bottom surface of the cooking chamber 30 and may be disposed on the upper surface of the slider inserted into the cooking chamber 30 described above. In addition, without the slider, the tray-type cookware (e.g., the multipurpose tray 81 of FIG. 5) may be directly inserted into a slit or a groove for inserting the slider into the side wall in the cooking chamber as described above.

A material of the tray-type cookware (e.g., the multipurpose tray 81 of FIG. 5) may be various. For example, at least a portion of the tray-type cookware (e.g., the multipurpose tray 81 of FIG. 5) may be formed of aluminum, stainless steel, steel, iron, copper, or metal including alloy thereof. In addition, for example, at least a portion of the tray-type cookware (e.g., the multipurpose tray 81 of FIG. 5) may be formed of a material, such as glass or ceramic. In addition, the tray-type cookware (e.g., the multipurpose tray 81 of FIG. 5) may be formed of, for example, a material, such as heat-resistant plastic.

The materials mentioned above may be selected based on the purpose of the tray-type cookware (e.g., the multipurpose tray 81 of FIG. 5). Furthermore, the shape of the tray-type cookware (e.g., the multipurpose tray 81 of FIG. 5) may also vary depending on the purpose of the tray-type cookware (e.g., the multipurpose tray 81 of FIG. 5).

Referring to FIG. 5, the multipurpose tray 81 that may be used in the cooking chamber is illustrated. The multipurpose tray 81 may be formed of the materials described above. In addition, the multipurpose tray 81 may include, for example, a concave space 811 to accommodate food and a slider shape 812 provided at one side and the other side that allows to be directly inserted into the side wall in the cooking chamber, as described above.

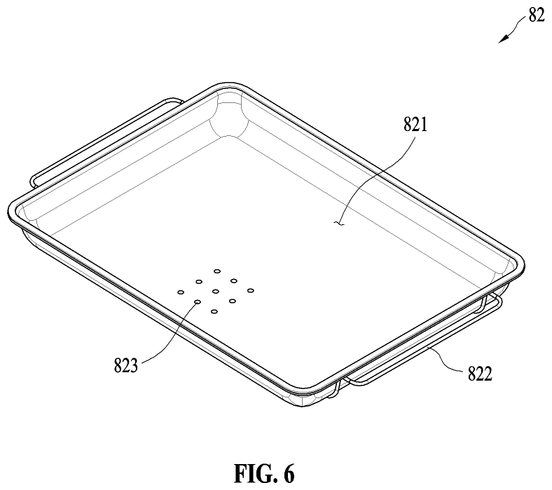

Referring to FIG. 6, a tray for air frying 82 disposed in the oven according to one embodiment is illustrated. The tray for air frying 82 may be formed of, for example, a metal material to conduct heat to the bottom surface of the food effectively. In addition, for example, the tray for air frying 82 may include a concave space 821 for accommodating food and a discharge hole 823 formed on the bottom surface of the concave space. As oil from the food through the discharge hole 823 is discharged to the outside of the tray for air frying 82, the food may not be fried by oil and may be cooked mainly by radiant heat and convection heat.

In addition, the tray for air frying 82 may include a gripping structure 822 around the tray to allow the user to remove the tray from the cooking chamber without directly touching the heated tray after cooking is completed. For example, the gripping structure 822 may be formed of a material having low thermal conductivity and may be formed of a linear member.

Furthermore, the tray for air frying 82 may also include the slider shape (not shown) similar to the multipurpose tray (e.g., the multipurpose tray 81 of FIG. 5) mentioned above.

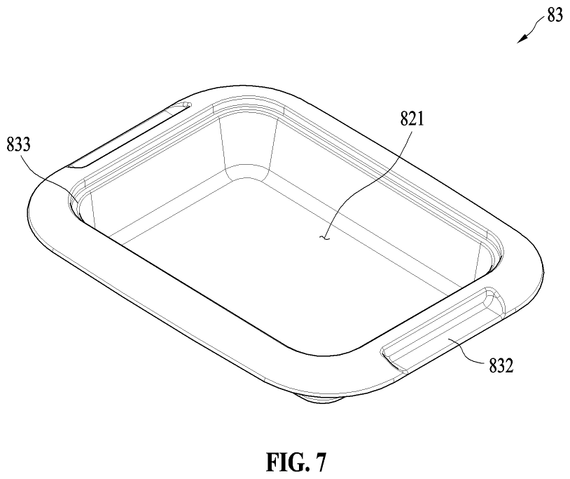

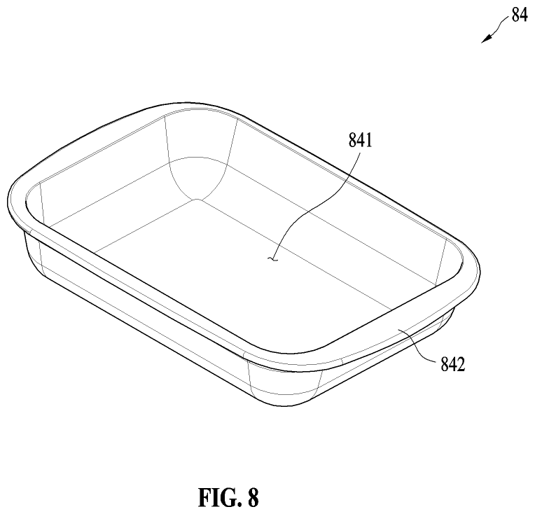

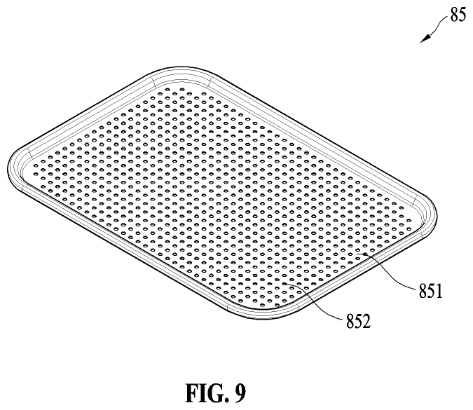

Referring to FIG. 7, a tray for steaming 83 disposed in an oven according to one embodiment is illustrated, referring to FIG. 8, glass for steaming 84 disposed in an oven according to one embodiment is illustrated, and referring to FIG. 9, a sub-tray for steaming 85 disposed on the tray for steaming 83 disposed in the oven according to one embodiment is illustrated.

For example, the tray for steaming 83 may include a concave space 831 for accommodating water to generate steam for steaming food.

In addition, the tray for steaming 83 may include a sub-tray for steaming seating surface 833 such that the sub-tray for steaming 85 that allows food to be spaced apart from water is disposed on the upper part of the concave space 831. In addition, the tray for steaming 83 may include a gripping portion 832 in one and the other sides of the tray for steaming 83.

Furthermore, the user may use the glass for steaming 84 instead of the tray for steaming 83 depending on the purpose.

Furthermore, for example, to secure a sufficient water height even if a relatively small amount of water is accommodated in the concave space 831 as well as to reduce a time consumed for the water to boil, the tray for steaming 83 may be relatively small compared to other tray-type cookware (e.g., the multipurpose tray 81 of FIG. 5) that are large enough to directly slide relative to both side walls of the cooking chamber.

The sub-tray for steaming 85 may include a placement surface 851 on which food is disposed and a discharge hole 852 that allows to steam food as the water accommodated in the concave space 831 of the tray for steaming 83 is sprayed and passes through the sub-tray for steaming 85.

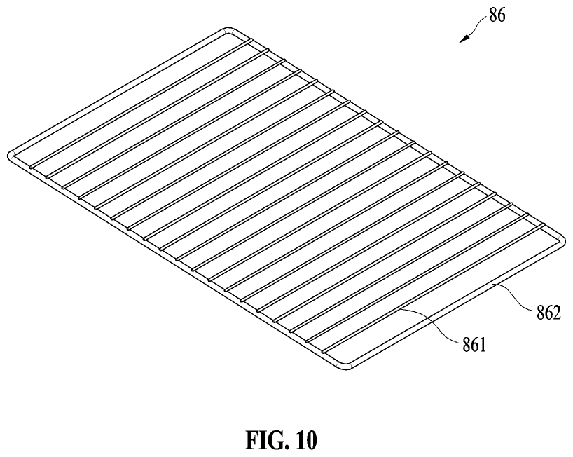

FIG. 10 is a perspective view of wire-type cookware 86 disposed in an oven according to one embodiment. The wire-type cookware 86 may include a grill portion 861 on which food is disposed and a structure 862 that may be gripped by a user or may slide relative to the side wall of the cooking chamber.

For example, the grill portion 861 may include a plurality of wires and intervals thereof may be variously determined.

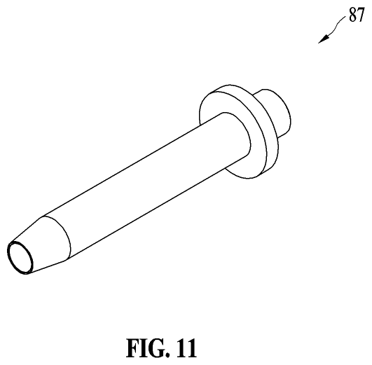

FIG. 11 is a perspective view of a steam pipe 87 disposed in an oven according to one embodiment.

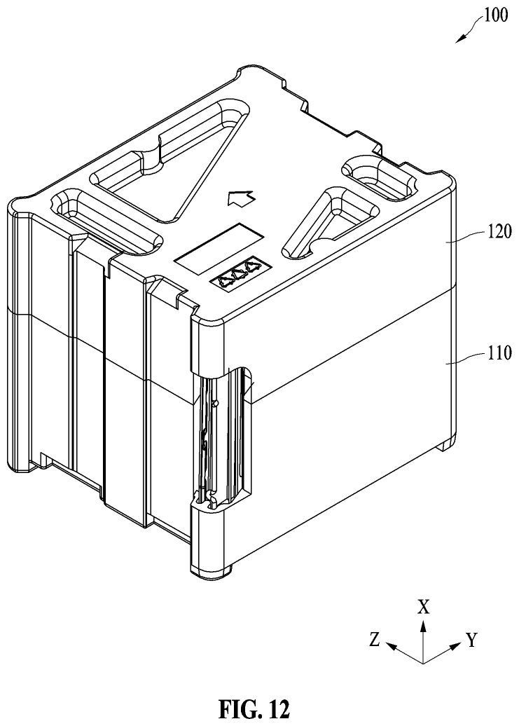

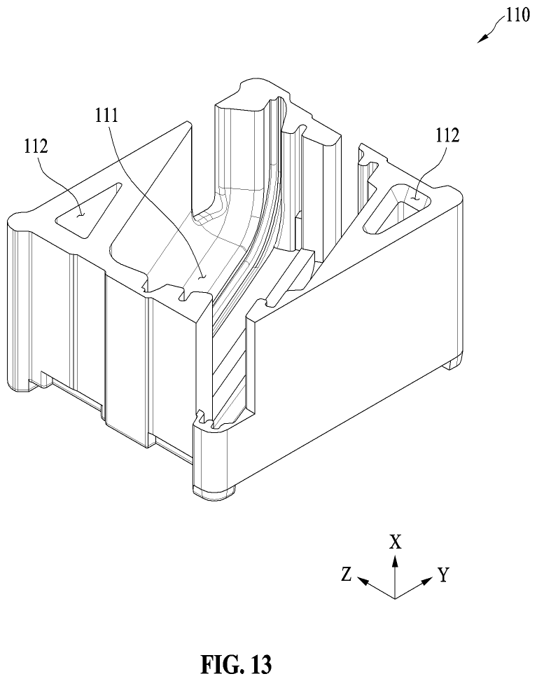

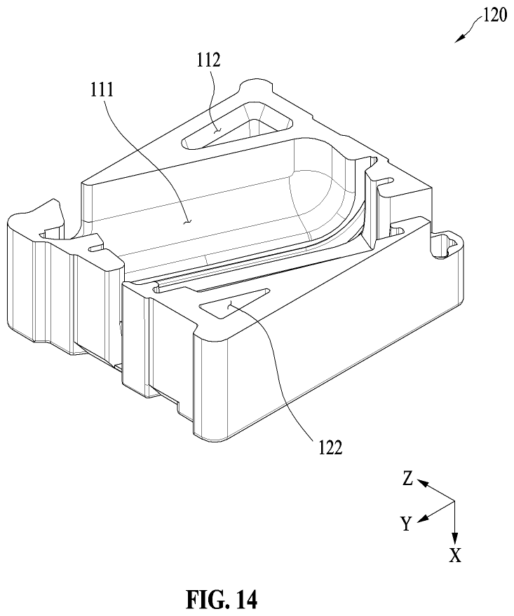

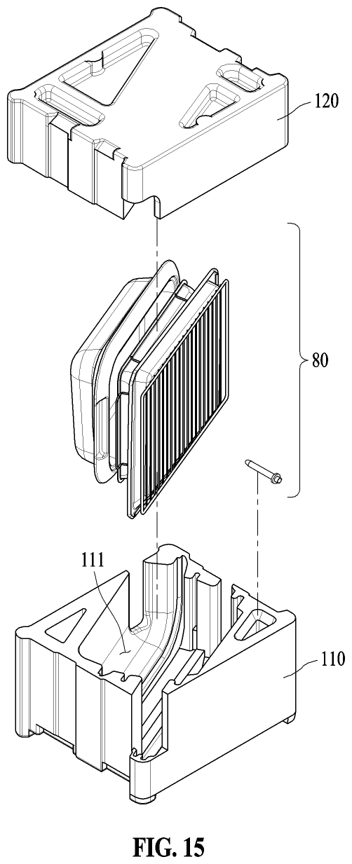

FIG. 12 is a perspective view of a packaging assembly 100 according to one embodiment, FIG. 13 is a perspective view of a first packaging material 110 of the packaging assembly 100 according to one embodiment, FIG. 14 is a perspective view of a second packaging material 120 of the packaging assembly 100 according to one embodiment, and FIG. 15 illustrates an accommodation relationship and a combination relationship between the packaging assembly 100 and cookware that may be accommodated in the packaging assembly 100 according to one embodiment.

The packaging assembly 100 may accommodate, for example, the cookware 80 (e.g., the multipurpose tray 81 of FIG. 5) as shown in FIG. 15 and referring to FIG. 12, the packaging assembly 100 may include the first packaging material 110 and the second packaging material 120 in contact with the first packaging material 110 to accommodate the cookware in one and the other sides.

For example, the first packaging material 110 and the second packaging material 120 may have a hexahedral shape, and a surface in which the first packaging material 110 and the second packaging material 120 are in contact therewith may be expressed as a surface where one hexahedron is cut into one plane. Furthermore, the surface in which the first packaging material 110 and the second packaging material 120 are in contact therewith may be a curved surface.

The first packaging material 110 and the second packaging material 120 may be connected to each other by contacting each other and may form one packaging assembly 100.

Furthermore, the first packaging material 110 and the second packaging material 120 may be formed of Styrofoam.

Referring to FIG. 13, an interior of the first packaging material 110 is illustrated. For example, the first packaging material 110 may include a first accommodation space 111 open toward the second packaging material 120 while the first packaging material 110 is in contact with the second packaging material 120.

For example, the first accommodation space 111 may communicate with the outside as the first accommodation space 111 extends by penetrating the first packaging material 110 in a direction perpendicular to an opening direction to more easily accommodate cookware depending on the size of the cookware accommodated therein.

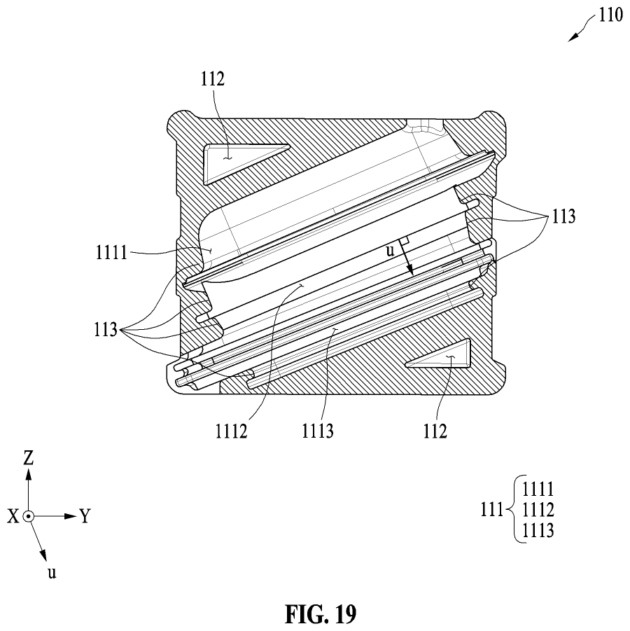

In addition, a first separation rib (e.g., a first separation rib 113 of FIG. 19) may be formed in the first accommodation space 111 to accommodate cookware (e.g., the multipurpose tray 81 of FIG. 5) in a proper position as described below.

The first accommodation space 111 may be connected to a second accommodation space (e.g., a second accommodation space 121 of FIG. 14), which is described below, and may form one accommodation space.

In addition, the first packaging material 110 may include a first additional accommodation space 112 spaced apart from the first accommodation space 111. The first additional accommodation space 112 may accommodate, for example, a steam pipe (e.g., the steam pipe 87 of FIG. 11). Furthermore, as the first additional accommodation space 112 expands, an amount of a material used for the first packaging material 110 may be reduced.

Referring to FIG. 14, an interior of the second packaging material 120 is illustrated. For example, the second packaging material 120 may include the second accommodation space 121 open toward the first packaging material 110 while the first packaging material 110 is in contact with the second packaging material 120. The second accommodation space 121 may be connected to the first accommodation space 111 when the first packaging material 110 and the second packaging material 120 contact each other as described above.

For example, similar to the first accommodation space 111, the second accommodation space 121 may communicate with the outside as the second accommodation space 121 extends by penetrating the second packaging material 120 in a direction perpendicular to an opening direction to more easily accommodate cookware depending on the size of the cookware accommodated therein.

In addition, similar to the first accommodation space 111, the second accommodation space 121 may include a second separation rib (e.g., a second separation rib 123 of FIG. 19).

In addition, similar to the first accommodation space 110, the second packaging material 120 may include a second additional accommodation space 122 spaced apart from the second accommodation space 121. The function and advantage thereof may be the same as the first additional accommodation space 112 of FIG. 13.

Referring to FIG. 15, the cookware 80 may enter and may be accommodated in the first accommodation space 111 along a dotted line, and thereafter, packaging of the cookware 80 may be completed as the second packaging material 120 accommodates and covers a portion of the first packaging material 110 of the cookware 80 exposed to the outside and the first packaging material 110 is in contact with the second packaging material 120.

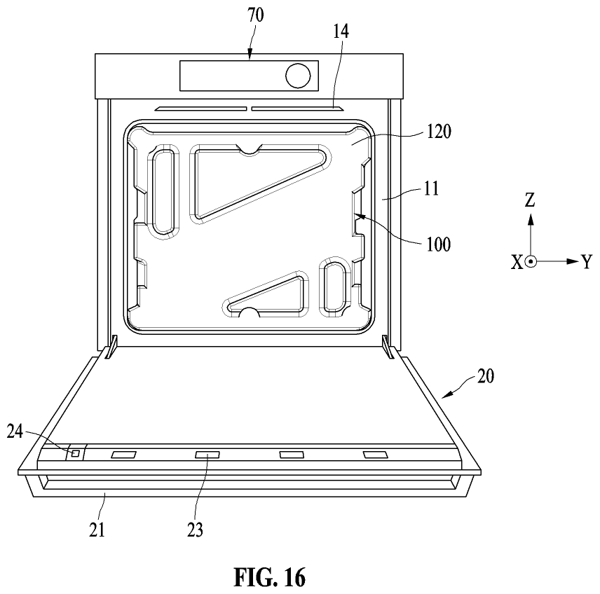

Referring to FIG. 16, a state in which the packaging assembly 100 is accommodated in a cooking chamber is illustrated. For example, since the packaging assembly 100 may have an external figure (e.g., a hexahedron) corresponding to a cooking chamber (e.g., the cooking chamber 30 of FIG. 2), the packaging assembly 100 may fit in the cooking chamber (e.g., the cooking chamber 30 of FIG. 2).

Although FIG. 16 illustrates that the packaging assembly 100 is disposed in a cooking chamber (e.g., the cooking chamber 30 of FIG. 2) such that the second packaging material 120 faces a first direction (e.g., the +x direction of FIG. 16), the disposition orientation of the packaging assembly 100 is not limited thereto and may vary. For example, the first packaging material 110 may be disposed to face the first direction, and depending on the size of the hexahedron of the packaging assembly 100, the packaging assembly 100 may be disposed in the cooking chamber such that the first packaging material 110 faces a second direction perpendicular to the first direction.

As described above, there is no need to deliver cookware separately from an oven when delivering the oven to a customer by accommodating the packaging assembly 100, which accommodates the cookware (e.g., the cookware 80 of FIG. 15), in the cooking chamber of the oven. This may reduce a transportation cost and may save labor by allowing only an oven to be transported. In addition, the risk of losing cookware during transportation may be reduced.

In addition, by accommodating the cookware in the cooking chamber using the packaging assembly 100, a risk of damage to the cookware and the oven may be reduced compared to a case in which the cookware is accommodated in the cooking chamber and transported without the packaging assembly 100. For example, if the cookware is accommodated in the cooking chamber without the packaging assembly 100, the cookware may shake in the cooking chamber during transportation according to a transportation state and may impact on the interior of the cooking chamber.

In addition, the packaging assembly 100 may allow the cookware to maintain their positions to prevent from colliding with each other. A first separation rib (e.g., the first separation rib 113 of FIG. 19) and a second separation rib (e.g., the second separation rib 123 of FIG. 19) to be described below may prevent cookware from colliding with each other.

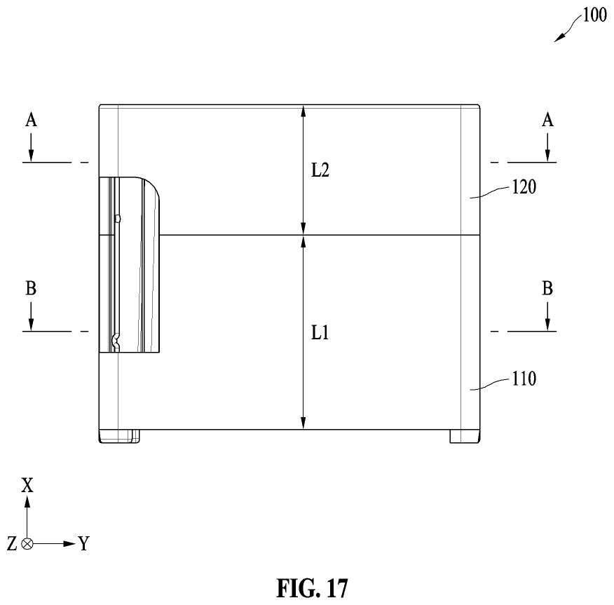

FIG. 17 is a side view of the packaging assembly 100 according to one embodiment. FIG. 17 shows the lengths of the first packaging material 110 and the second packaging material 120 in a first direction (e.g., the +x direction of FIG. 17). A length L1 of the first packaging material 110 in the first direction may be greater than a length L2 of the second packaging material 120 in a second direction. For example, the length L1 of the first packaging material 110 in the first direction may be 1.4 to 2 times the length L2 of the second packaging material 120 in the first direction.

For example, when the length L1 of the first packaging material 110 in the first direction is greater than the length L2 of the second packaging material 120 in the first direction, after cookware (e.g., the cookware 80 of FIG. 15) is accommodated in the first packaging material 110, the cookware may be easily accommodated in the second packaging material 120. The reason is as follows.

For example, a first accommodation space (e.g., the first accommodation space 111 of FIG. 13) of the first packaging material 110 may be formed with the design tolerance to easily insert cookware (e.g., the cookware 80 of FIG. 15) into the first packaging material 110 rather than being formed to fit tightly in the shape of cookware to be accommodated therein.

Due to the design tolerance, cookware (e.g., the cookware 80 of FIG. 15) accommodated in the first packaging material 110 may tilt in a range of the design tolerance of the first accommodation space (e.g., the first accommodation space 111 of FIG. 13). The tilting may cause an end portion in the first direction of the cookware (e.g., the cookware 80 of FIG. 15) to not maintain its position (e.g., a position when the cookware is not tilted). In this case, to accommodate the end portion in the first direction of the cookware (e.g., the cookware 80 of FIG. 15) in the second packaging material 120, the position may need to be adjusted within the design tolerance range of a second accommodation space (e.g., the second accommodation space 121 of FIG. 14) of the second packaging material 120.

The tilt problem that causes a difficulty in accommodation of the cookware (e.g., the cookware 80 of FIG. 15) in the first packaging material 110 and the second packaging material 120 described above may be improved by increasing the length L1 of the first packaging material 110 in the first direction to be longer than the length L2 of the second packaging material 120 in the first direction.

As the length L1 of the first packaging material 110 in the first direction increases, the first packaging material 110 may support a portion of the cookware (e.g., the cookware of FIG. 15) away in the first direction, and thereby, the tilt problem may be mitigated.

For example, the length L1 of the first packaging material 110 in the first direction may be designed to 183 mm, the length L2 of the second packaging material 120 in the first direction may be designed to 107 mm, and for a comparison example, the length L1 of the first packaging material 110 in the first direction may be designed to 145 mm, and the length L2 of the second packaging material 120 in the first direction may be designed to 145 mm. In the former case, a ratio of lengths (L1/L2) may be 1.7 times and in the latter case, the ratio of lengths may be 1 time. As a result of experiments with the two cases, in the latter case of the comparative example, cookware (e.g., the cookware 80 of FIG. 15) accommodated therein may be tilted up to 2.5 degrees and in the former case of the packaging assembly 100 according to one embodiment may be tilted up to 1.5 degrees. Through this, it may be acknowledged that the assemblability of the packaging assembly 100 is improved.

The degree of improvement of tilting may further increase as the ratio of L1/L2 increases. However, when the length L1 of the first packaging material 110 in the first direction infinitely extends compared to the length L2 of the first packaging material 110 in the first direction, for example, the first packaging material 110 manufactured by Styrofoam injection molding may not be easily discharged from a mold. Therefore, it may be preferable to set L1/L2 to up to 2 times in an aspect of a manufacturing process.

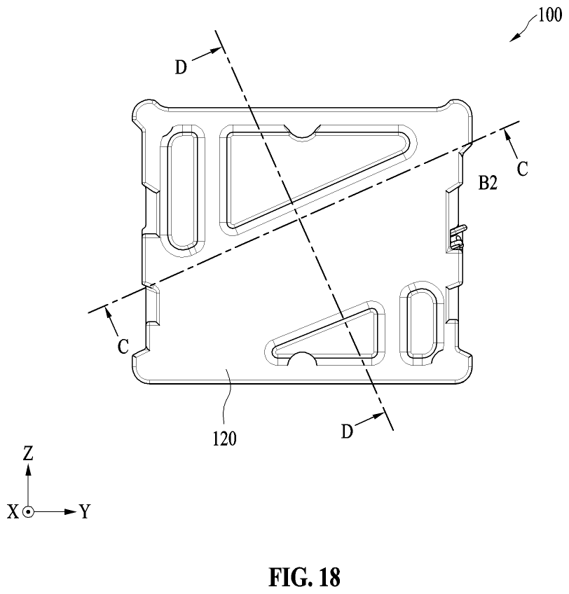

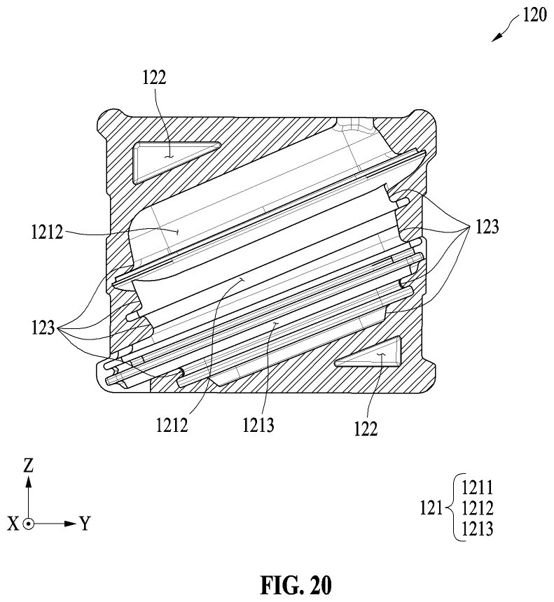

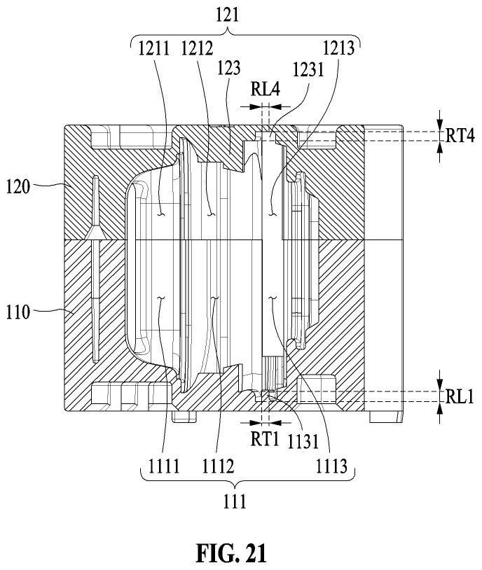

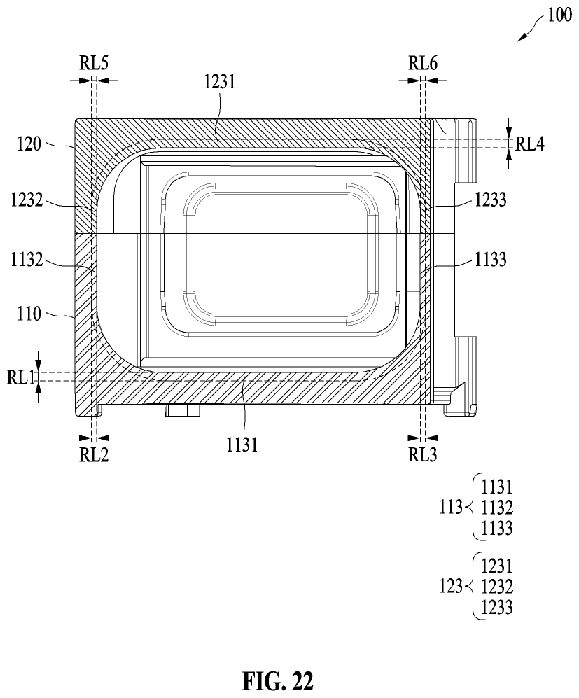

FIG. 18 is a plan view of the packaging assembly 100 according to one embodiment, FIG. 19 is a cross-sectional view of the first packaging material 110 of the packaging assembly 100 taken along line B-B (FIG. 17) according to one embodiment, FIG. 20 is a cross-sectional view of the second packaging material 120 of the packaging assembly 100 taken along line A-A (FIG. 17) according to one embodiment, FIG. 21 is a cross-sectional view of the packaging assembly 100 taken along line D-D (FIG. 18) according to one embodiment, and FIG. 22 is a cross-sectional view of the packaging assembly 100 taken along line C-C(FIG. 18) according to one embodiment. Hereinafter, detailed descriptions of internal structures of the first packaging material 110 and the second packaging material 120 are provided with reference to FIGS. 17 to 22.

Referring to FIG. 19, the first packaging material 110 may include at least one first separation rib 113. The at least one first separation rib 113 may be formed such that at least a portion thereof continuously protrudes toward the center of the first accommodation space 111 from an inner surface of the first packaging material 110.

Referring to FIG. 22, the first separation rib 113 that continuously protrudes toward the center of the first accommodation space 111 from the inner surface of the first packaging material 110 is illustrated. A portion indicated by a dotted line may be a portion in which a separation rib is not formed and the illustrated cross-section may be a cross-section of the first separation rib 113.

The first separation rib 113 may protrude by RL1, RL2, or RL3 in each direction from the inner surface of the first packaging material 110 in which a separation rib is not formed. For example, the first separation rib 113 may be continuously formed by surrounding the inner surface of the first accommodation space 111.

However, some of the first separation ribs 113 may not be formed to surround the entire inner surface of the first packaging material 110 as shown in FIG. 22 and may be continuously formed only in a partial section. The protruding length of the first separation rib 113 in each direction is described later.

Referring back to FIG. 19, the first separation ribs 113 having various shapes and sizes are illustrated. The first accommodation space 111 formed in the first packaging material 110 may be defined as a curved surface of which one side is open in the first packaging material 110, and the first separation rib 113 may refer to all protruding portions on the curved surface.

For example, the first separation ribs 113 shown in FIG. 19 may have various protruding lengths, thickness of protruding portions, and protruding shapes.

The at least one first separation rib 113 may be arranged adjacent to each other at intervals. The arrangement direction and arrangement interval thereof may vary.

For example, an interval between adjacent first separation ribs 113 may be variously formed depending on an accommodation target.

For example, the at least one first separation rib 113 may be arranged at intervals in the first direction (e.g., the +u direction of FIG. 19). For example, since the size and shape of the packaging assembly 110 are determined to fit and to be accommodated in a limited space (e.g., the cooking chamber 30 of FIG. 2), the packaging assembly 100 may be diagonally arranged to accommodate large cookware (e.g., the cookware of FIG. 15) in the limited space.

The first accommodation space 111 may be partitioned into a plurality of areas by the first separation rib 113. For example, some of the first separation ribs 113 may partition the first accommodation space 111 into three areas and some of the remainder of the first separation ribs 113 may be disposed in the three areas. For example, the first accommodation space 111 may include a first area 1111, a second area 1112, and a third area 1113.

A portion of the tray-type cookware (e.g., the multipurpose tray 81 of FIG. 5) and/or the wire-type cookware (e.g., the wire-type cookware 86 of FIG. 10) described above may be accommodated in each of the first area 1111, the second area 1112, and the third area 1113.

Referring to FIG. 20, the second packaging material 120 may include at least one second separation rib 123. The at least one second separation rib 123 may be formed such that at least a portion thereof continuously protrudes toward the center of the second accommodation space 121 from an inner surface of the second packaging material 120.

Referring to FIG. 22, the second separation rib 123 that continuously protrudes toward the center of the second accommodation space 121 from the inner surface of the second packaging material 120 is illustrated. A portion indicated by a dotted line may be a portion in which a separation rib is not formed and the illustrated cross-section may be a cross-section of the second separation rib 123.

The second separation rib 123 may protrude by RL4, RL5, or RL6 in each direction from the inner surface of the second packaging material 120 in which a separation rib is not formed.

Similar to the first separation rib 113, the second separation rib 123 may be partially continuous or may continuously surround the entire surface.

Referring back to FIG. 20, the second separation ribs 123 having various shapes and sizes are illustrated. Similar to the first packaging material 110, the second accommodation space 121 formed in the second packaging material 120 may be defined as a curved surface of which one side is open in the second packaging material 120, and the second separation rib 123 may refer to all protruding portions on the curved surface.

For example, the second separation ribs 123 shown in FIG. 20 may have various protruding lengths, thickness of protruding portions, and protruding shapes.

The at least one second separation rib 123 may be arranged adjacent to each other at intervals. The arrangement direction and arrangement interval thereof may vary.

For example, an interval between adjacent second separation ribs 123 may be variously formed depending on an accommodation target.

For example, the at least one second separation rib 123 may be arranged at intervals in the first direction.

The second accommodation space 121 may be partitioned into a plurality of areas by the second separation rib 123. For example, some of the second separation ribs 123 may partition the second accommodation space 121 into three areas and some of the remainder of the second separation ribs 123 may be disposed in the three areas. For example, the second accommodation space 121 may include a fourth area 1211, a fifth area 1212, and a sixth area 1213.

A portion of the tray-type cookware (e.g., the multipurpose tray 81 of FIG. 5) and/or the wire-type cookware (e.g., the wire-type cookware 86 of FIG. 10) described above may be accommodated in each of the fourth area 1211, the fifth area 1212, and the sixth area 1213, wherein the portion is a remaining portion that is not accommodated in the first area 1111, the second area 1112, and the third area 1113.

Referring to FIGS. 19 to 21, the direction in which the first separation rib 113 and the second separation rib 123 are formed may be the same, which is the first direction. In addition, the first area 1111 and the fourth area 1211, the second area 1112 and the fifth area 1212, and the third area 1113 and the sixth area 1213 may correspond to each other and may be connected to each other. In addition, the protruding heights of the first separation rib 113 and the second separation rib 123 may be the same in an area where the first packaging material 110 is in contact with the second packaging material 120.

Hereinafter, referring to FIGS. 21 and 22, the protruding lengths and the thickness of the protruding portions of the first separation rib 113 and the second separation rib 123 are described.

The first separation rib 113 of the first packaging material 110 may include a first rib element 1131 protruding toward the second packaging material 120, a second rib element 1132 and a third rib element 1133 that are connected to the first rib element 1131. For example, the protruding length RL1 of the first rib element 1131 may be constant in the entire section in which the first rib element 1131 is continuous, and may increase or decrease toward the second rib element 1132 or the third rib element 1133. In addition, the protruding length RL2 of the second rib element 1132 and the protruding length RL3 of the third rib element 1133 may be constant in the entire continuous section or may increase or decrease depending on the section, respectively.

For example, a portion in which the first rib element 1131 is connected to the second rib element 1132 and a portion in which the first rib element 1131 is connected to the third rib element 1133 may be rounded to avoid angled edges.

The second separation rib 123 of the second packaging material 110 may include a fourth rib element 1231 protruding toward the first packaging material 110, a fifth rib element 1232 and a sixth rib element 1233 that are connected to the fourth rib element 1231. For example, the protruding length RL4 of the fourth rib element 1231 may be constant in the entire section in which the fourth rib element 1231 is continuous, and may increase toward the fifth rib element 1232 or the sixth rib element 1233. In addition, the protruding length RL5 of the fifth rib element 1232 and the protruding length RL6 of the sixth rib element 1233 may be constant in the entire continuous section or may increase or decrease depending on the section, respectively.

For example, the protruding length RL4 of the fourth rib element 1231 may be shorter than the protruding length RL1 of the first rib element 1131. In addition, the protruding length RL4 of the fourth rib element 1231 may be shorter than the protruding length RL5 of the fifth rib element 1232 and the protruding length RL6 of the sixth rib element 1233.

For example, the protruding length RL4 of the fourth rib element 1231 may be shorter than protruding lengths of any other rib elements.

Referring to FIG. 21, the fourth rib element 1231 of the second separation rib 123 of which at least a portion does not protrude toward the first packaging material 110 is illustrated. This may be the separation rib portion illustrated as a dotted line in FIG. 21. Although FIG. 21 illustrates that a specific portion of the second rib element 1132 is shown as a dotted line and does not protrude, but the non-protruding portion of the second rib element 1132 may be positioned at a different portion.

In addition, referring to FIG. 21, a thickness RT4 measured in the first direction (e.g., the +u direction of FIG. 19) of the protruding portion of the second rib element 1132 may be shorter than a thickness RT1 measured in the first direction of the protruding portion of the first rib element 1131. For example, the thickness RT4 may be 0.

As shown in FIGS. 21 and 22, as a portion of the second separation rib 123 is shorter or thinner than other parts, or does not protrude, cookware including a thin material, such as the wire-type cookware 86 (e.g., the wire-type cookware 86 of FIG. 10), may be easily accommodated.

For example, the cookware including a thin material may be more tilted by the design tolerance in the first accommodation space 111 and the second accommodation space 121. A tool may be accommodated without potential interference that may occur in a portion in which the tool that is greatly tiltable is accommodated by removing the portion of the second separation rib 123 or decreasing the portion to be shorter than other parts.

According to various embodiments, the packaging assembly 100 for packaging the cookware 80 for an oven including the cooking chamber 30 therein may include the first packaging material 110 and the second packaging material 120 in contact with the first packaging material 110, the first packaging material 110 may include the first accommodation space 111 that is open toward the second packaging material 120, the second packaging material 120 may include the second accommodation space 121 that is open toward the first packaging material 110, the packaging assembly 100 may have an external figure corresponding to the cooking chamber 30 to be accommodated in the cooking chamber 30, and the length of the first packaging material 110 in the first direction toward the first packaging material 110 from a surface in which the first packaging material 110 and the second packaging material 120 are in contact with each other may be greater than the length of the second packaging material 120 in the first direction.

According to various embodiments, the first packaging material 110 may include at least one first separation rib 113, at least a portion of the first separation rib 113 may protrude toward the center of the first accommodation space 111 from the inner surface of the first packaging material, the second packaging material 120 may include at least one second separation rib 123, and at least a portion of the second separation rib 123 may protrude toward the center of the second accommodation space 121 from the inner surface of the second packaging material 120.

According to various embodiments, a degree of protrusion of the first separation rib 113 may be the same as a degree of protrusion of the second separation rib 123 in a portion in which the first separation rib 113 is in contact with the second separation rib 123.

According to various embodiments, a plurality of first separation ribs 113 may be provided and the plurality of first separation ribs 113 may be arranged adjacent to each other at intervals, and a plurality of second separation ribs 123 may be provided and the plurality of second separation ribs 123 may be arranged adjacent to each other at intervals.

According to various embodiments, the protruding length of a protruding portion in the first direction of at least one of the second separation ribs 123 may be less than or equal to the protruding length of a protruding portion in a direction that is opposite to the first direction of at least one of the first separation ribs 113.

According to various embodiments, the protruding length of the protruding portion in the first direction of at least one of the second separation ribs 123 may be less than or equal to protruding lengths of portions other than the portion.

According to various embodiments, at least a portion of at least one of the second separation ribs 123 may not protrude in the first direction.

According to various embodiments, the thickness of a protruding portion in the first direction of at least one of the second separation ribs 123 may be less than or equal to the thickness of a protruding portion in the direction that is opposite to the first direction of a portion of the first separation ribs 113 connected to the at least one of the second separation ribs 123.

According to various embodiments, the length in the first direction of the first packaging material 110 may be 1.4 times or twice the length in the first direction of the second packaging material 120.

According to various embodiments, the first packaging material 110 may include the first additional accommodation space 112 spaced apart from the first accommodation space 111, and the second packaging material 120 may include the second additional accommodation space 122 spaced apart from the second accommodation space 121.

According to various embodiments, when the first packaging material 110 is in contact with the second packaging material 120, the first accommodation space 111 may be connected to the second accommodation space 121 and the first additional accommodation space 112 may be connected to the second accommodation space 122.

According to various embodiments, the packaging assembly 100 may have a hexahedral external figure.

According to various embodiments, the at least one first separation rib 113 and the at least one second separation rib 123 may be diagonally arranged in the hexahedron.

According to various embodiments, at least one wire-type cookware 86 and at least one tray-type cookware may be accommodated in the first accommodation space 111 and the second accommodation space 121, and
a steam pipe is accommodated in the first additional accommodation space 112 and the second additional accommodation space 122.

According to various embodiments, the first accommodation space 111 and the second accommodation space 121 may be partitioned into two or more areas, and the wire-type cookware 86 and the tray-type cookware may be accommodated together in at least one of the areas.

According to various embodiments, in the area in which the wire-type cookware and the tray-type cookware are accommodated together, a protruding portion in the first direction of the second separation rib 123 may have a shorter protruding length than other protruding portions in the first direction of the second separation rib 123.

According to various embodiments, among the at least one second separation rib 123, a protruding portion in the first direction of the second separation rib 123 disposed in the at least one area may be shorter than a protruding portion in the first direction of other second separation ribs 123.

According to various embodiments, the packaging assembly 100 packaging an accessory of a home appliance product including a cavity therein, may include the first packaging material 110 and the second packaging material 120 in contact with the first packaging material 110, the first packaging material 110 may include the first accommodation space 111 that is open toward the second packaging material 120, the second packaging material 120 may include the second accommodation space 121 that is open toward the first packaging material 110, when the first packaging material 110 is in contact with the second packaging material 120, the first accommodation space 111 may be connected to the second accommodation space 121, the packaging assembly 100 may have an external figure corresponding to the cavity to be accommodated in the cavity, and the length of the first packaging material in the first direction toward the first packaging material 110 from the surface in which the first packaging material 110 and the second packaging material 120 are in contact with each other may be greater than the length of the second packaging material 120 in the first direction.

According to various embodiments, the first packaging material 110 may include at least one first separation rib 113, at least a portion of the first separation rib 113 may protrude toward the center of the first accommodation space 111 from the inner surface of the first packaging material 110, the second packaging material 120 may include at least one second separation rib 123, at least a portion of the second separation rib 123 may protrude toward the center of the second accommodation space 121 from the inner surface of the second packaging material 120, and the protruding length of a protruding portion in the first direction of at least one of the second separation ribs 123 may be less than or equal to the protruding length of a protruding portion in a direction that is opposite to the first direction of at least one of the first separation ribs 113.

According to various embodiments, a plurality of first separation ribs 113 may be provided and the plurality of first separation ribs 113 may be arranged adjacent to each other at intervals, a plurality of second separation ribs 123 may be provided and the plurality of second separation ribs 123 may be arranged adjacent to each other at intervals, and the at least one first separation rib 113 and the at least one second separation rib 123 may be diagonally arranged in the packaging assembly 100 having the hexahedral shape.

According to various embodiments, the oven 1 may include the main body 10, the cooking chamber 30, which is provided in the main body 10, is open toward one side of the main body 10, and has a hexahedral shape, the door 20 that opens and closes the cooking chamber 30 in the one side of the main body 10, the control panel 70 installed in the main body 10 at the upper portion of the one side of the main body 10, and the packaging assembly 100 accommodated in the cooking chamber 30, the packaging assembly 100 may include the first packaging material 110 and the second packaging material 120 in contact with the first packaging material 110, the first packaging material 110 may include the first accommodation space 111 that is open toward the second packaging material 120, the second packaging material 120 may include the second accommodation space 121 that is open toward the first packaging material 110, the packaging assembly 100 may include an external figure corresponding to the cooking chamber 30 to be accommodated in the cooking chamber 30, the length of the first packaging material 110 in the first direction toward the first packaging material 110 from the surface in which the first packaging material 110 and the second packaging material 120 are in contact with each other may be greater than the length of the second packaging material 120 in the first direction, the first packaging material 110 may include at least one first separation rib 113, at least a portion of the first separation rib 113 may continuously protrude toward the center of the first accommodation space 111 from the inner surface of the first packaging material 110, the second packaging material 120 may include at least one second separation rib 123, and at least a portion of the second separation rib 123 may continuously protrude toward the center of the second accommodation space 121 from the inner surface of the second packaging material 120, and the protruding length of a protruding portion in the first direction of the at least one of the second separation ribs 123 may be less than or equal to the protruding length of a protruding portion in a direction that is opposite to the first direction of the at least one of the first separation ribs 113.

What is claimed is:

1. A packaging assembly for packaging cookware for an oven that includes a cooking chamber, the packaging assembly comprising:
a first packaging material including a first accommodation space; and
a second packaging material including a second accommodation space, the second packaging material being in contact with the first packaging material while the first packaging material is coupled to the second packaging material, the first accommodation space being open toward the second packaging material and the second accommodation space being open toward the first packaging material,
wherein the packaging assembly comprises an external figure corresponding to the cooking chamber to be accommodated in the cooking chamber, and
a length of the first packaging material along a direction of the first packaging material from a surface of the first packaging material that contacts the second packaging material is greater than a length of the second packaging material along the direction.

2. The packaging assembly of claim 1, wherein the first packaging material comprises at least one first separation rib,
at least a portion of the at least one first separation rib protrudes toward a center of the first accommodation space from an inner surface of the first packaging material,
the second packaging material comprises at least one second separation rib, and
at least a portion of the at least one second separation rib protrudes toward a center of the second accommodation space from an inner surface of the second packaging material.

3. The packaging assembly of claim 2, wherein a degree of protrusion of the at least one first separation rib is same as a degree of protrusion of the at least one second separation rib in a portion in which the at least one first separation rib is in contact with the at least one second separation rib.

4. The packaging assembly of claim 3, wherein the at least one first separation rib is among a plurality of first separation ribs and the plurality of first separation ribs are arranged adjacent to each other at intervals, and
the at least one second separation rib is among a plurality of second separation ribs and the plurality of second separation ribs are arranged adjacent to each other at intervals.

5. The packaging assembly of claim 4, wherein a protruding length of a protruding portion in the direction of at least one of the plurality of second separation ribs is less than or equal to a protruding length of a protruding portion in a direction that is opposite to the direction of at least one of the plurality of first separation ribs.

6. The packaging assembly of claim 4, wherein a protruding length of a protruding portion in the direction of at least one of the plurality of second separation ribs is less than or equal to protruding lengths of portions other than the portion.

7. The packaging assembly of claim 4, wherein at least a portion of at least one of the plurality of second separation ribs does not protrude in the direction.

8. The packaging assembly of claim 4, wherein a thickness of a protruding portion in the direction of at least one of the plurality of second separation ribs is less than or equal to a thickness of a protruding portion in the direction that is opposite to the direction of a portion of the plurality of first separation ribs connected to the at least one of the plurality of second separation ribs.

9. The packaging assembly of claim 1, wherein a length along the direction of the first packaging material is 1.4 times or twice a length along the direction of the second packaging material.

10. The packaging assembly of claim 1, wherein the first packaging material comprises a first additional accommodation space spaced apart from the first accommodation space, and
the second packaging material comprises a second additional accommodation space spaced apart from the second accommodation space.

11. The packaging assembly of claim 10, wherein, when the first packaging material is in contact with the second packaging material, the first accommodation space is connected to the second accommodation space and the first additional accommodation space is connected to the second accommodation space.

12. The packaging assembly of claim 4, wherein the packaging assembly has an external figure of a hexahedron.

13. The packaging assembly of claim 12, wherein the at least one first separation rib and the at least one second separation rib are diagonally arranged in the hexahedron.

14. The packaging assembly of claim 11, wherein at least one wire-type cookware and at least one tray-type cookware are accommodated in the first accommodation space and the second accommodation space, and
a steam pipe is accommodated in the first additional accommodation space and the second additional accommodation space.

15. The packaging assembly of claim 14, wherein the first accommodation space and the second accommodation space are partitioned into two or more areas, and
the at least one wire-type cookware and the at least one tray-type cookware are accommodated together in at least one of the two or more areas.
